(19) United States
(12) Patent Application Publication
(10) Pub. No.: US 2024/0008471 A1
(43) Pub. Date: Jan. 11, 2024

(54) ARTHROPOD AND MOLLUSC ARRANGEMENT

(71) Applicant: THE JVR TRUST, Burswood (AU)

(72) Inventor: Christiaan JANSEN VAN RENSBURG, Burswood (AU)

(21) Appl. No.: 18/017,995

(22) PCT Filed: Jul. 27, 2020
(86) PCT No.: PCT/IB20/57056

§ 371 Date: Jan. 25, 2023

(51) Int. Cl. A01M 1/18; A01M 29/34

(52) U.S. Cl. CPC A01M 1/18; A01M 29/34

(57) ABSTRACT

The invention discloses an arthropod and mollusc arrangement, which includes a band having an inner side adapted to be attached to a trunk of a tree; an outer side having a sticky surface and being adapted to trap crawling arthropod and molluscs trying to cross the band; and batting material attached to the inner side and being adapted to fill crevasses on the bark of the trunk of the tree in order to prevent arthropod and molluscs to crawl between the band and the trunk of the tree. The batting material may be adapted to fill the crevasses on the inner side as the band is tensioned when applied around the trunk of the tree. The crevasses may be closed by the batting material, the arthropod and molluscs are forced to cross over the outer side of the band and get trapped in the sticky surface.

### FIELD OF INVENTION

The present invention relates to an arthropod (insects, arachnids, myriapods) and mollusc (gastropods) pesticide arrangement.

More particularly, the present invention relates to a pesticide arrangement to protect plants, humans and animals against arthropods and molluscs. It can be used on its own, or it can be used to also apply an arthropodicide, or to also apply a molluscicide or as a method to simultaneously apply both an arthropodicide and molluscicide.

### BACKGROUND TO INVENTION

Pesticides are used to protect crops and plants. Arthropodicides are substances in various formats (insecticides, arachnicides, etc.) used to kill different types of arthropods. Molluscicides, also known as snail baits, snail pellets, and snail sprays are pesticides for use against gastropods. Arthropodicides and molluscicides are generally used in agriculture or gardening for controlling pests which damage crops or other valued plants by feeding on them.

Various chemicals can be employed as a molluscicide, including:
(a) metal salts such as iron(III) phosphate, iron EDTA complex and aluminium sulphate, boric acid, relatively non-toxic, also used in organic gardening and farming;
(b) Metaldehyde;
(c) Methiocarb;
(d) Carbaryl;
(e) Acetylcholinesterase inhibitors, highly toxic to other animals and humans, acts also as a contact poison;
(f) Niclosamide;
(g) Formulations of cinnamon oil, soapbark, soybean oil and sunflower oil, relatively non-toxic, also used inorganic gardening and farming; and
(h) Caffeine.

Hence various formulations of snail baits that are dispersed in agricultural fields and home gardens as molluscicides throughout the world. The baits are highly palatable to snails and when they feed or get in contact with on the poisoned baits, they die. The known baits throughout the world are manufactured as a solid, lose or individual bait.

PCT/IB2017/057489 discloses a pesticide arrangement, which includes at least one pesticide bait having at least one hole therein. The arrangement may include a piece of string, thread, rope, elastic, cord, wire and/or any other suitable material running through the hole. The arrangement is adapted to be placed around the bottom section or upper section of a tree or plant's trunk, branches and/or posts and/or be placed around fence posts or similar objects surrounding fields of plants that need protection and/or be placed directly on the ground in various lengths to form a barrier between plants and pest and/or be laid directly onto the ground or surface and/or be laid around fields or in between rows of plants or trees.

Also known are sticky bands surrounding the trunk of a tree. When arthropods come into contact with the sticky band, they get trapped in the glue and die. Typically these bands are variations of double sided sticky tapes on roll or glue or grease sold separately to be applied directly on tree trunk, or applied onto paper or fabric applied around a tree trunk. The trouble with the known products and methods are that the insects crawl underneath them and are able to reach the canopy of the plant.

A further shortcoming of the known products and methods is that gastropods, unlike arthropods can navigate their way across the glue surface and can reach the canopy of the plant to cause damage.

Furthermore, when gastropods cross the glue surface, they leave a slime trail behind on the surface of the glue. When the slime dries, it creates a “bridge” across the glue allowing crawling insects to cross the glue barriers unharmed and enter the plant canopy to cause damage.

It is an object of the invention to suggest a novel arthropod and mollusc arrangement which will overcome the aforementioned problems.

Various chemicals not listed in this document can be employed as a pesticide. It is the object of this invention to suggest that all these chemicals can be used in this novel pesticide arrangement.

Hereinafter the term bait includes reference to a pellet, granule, bead, crumb, powder or the like.

Hereinafter the term covering includes reference to encasing.

### SUMMARY OF INVENTION

According to the invention, an arthropod and mollusc arrangement includes a band having
(a) an inner sticky or non-sticky side adapted to be attached to a trunk of a tree;
(b) an outer side having a sticky surface and being adapted to trap crawling arthropods trying to cross the band; and
(c) batting material attached to the inner side and being adapted to fill crevasses on the bark of the trunk of the tree in order to prevent insects to crawl between the band and the trunk of the tree.

The band may be made of plastics material, paper, fabric, etc.

The band may be tensioned.

The batting material may fill the crevasses on the inner side as the band is tensioned when applied around the trunk of the tree.

The batting may be of varying width.

The batting may be narrower or broader than the band.

When the crevasses are closed by the batting material, the arthropods may be forced to cross over the outer side of the band and get trapped in the sticky surface.

The sticky surface may include glue.

The surface may also include substances that are slippery, greasy, oily and/or contain surfactants and/or other chemicals, or have other characteristics that are deterring, prohibitive or preventative to arthropods and molluscs wanting to cross it.

The glue may be non-toxic or toxic to arthropods and molluscs.

The glue may contain human and mammal taste repellent such as Denatonium Benzoate.

The glue may contain human and mammal smell deterrent.

The arthropod and mollusc arrangement may be visually deterring to humans or mammals.

The outer side may be sticky and be adapted to trap crawling arthropods such as ants, beetles, weevils, earwigs, millipedes, caterpillars, etc. trying to cross the band and reach the top of the tree.

The arthropod and mollusc arrangement may be used without pesticides and may thus be non-chemical free and/or toxic-free/pesticide-free.

The arrangement may contain and arthropod and/or mollusc luring agent (attractant), or it may contain no luring agent (attractant).

Arthropodicides, molluscicides and other pesticides may be applied to the band.

Arthropodicides, molluscicides and other pesticides may be impregnated into the band material.

Arthropodicides, molluscicides and other pesticides may be applied to the surface of the inner side of the band and/or the outer side of the band.

The Arthropodicides, molluscicides and other pesticides may be sprayed onto the band.

The batting material may be treated and/or sprayed with an arthropodicides (various types) to act as a further barrier against arthropods attempting to crawl underneath the band to reach the top of the tree.

When the arthropods come into contact with the treated batting material, they may die.

The arthropod arrangement may be adapted to act as a vehicle (or method) to apply existing arthropodicides.

Regular arthropodicide baits may be glued or molded to the band.

Regular snail bait and/or pellets may be applied to the outer side of the band to serve as molluscicides.

The snail bait and/or pellets may be glued or molded to the band.

The arthropod arrangement may thus be adapted to act as a vehicle (or method) to apply molluscicides.

When snails and slugs try to cross the pellets to reach the top of the tree, they feed and may die as a result of ingestion or contact.

The bond of the baits to the band may be stronger than known products.

The manufacturing process may be much improved, simpler, faster and ultimately more cost effective than known processes.

The arthropod arrangement may be adapted to act as a mollusc bait and/or other arthropod baits.

The outer side may be adapted to act as an arthropodicide and hence when insects try to cross the baits, they feed and die on contact.

The arthropod and mollusc arrangement may be adapted to be used as a barrier to prevent snails and slugs from climbing up tree trunks and/or posts to feed on the higher lying foliage, flowers and fruits or to seek refuge.

The arthropod and mollusc arrangement may be placed around the bottom section of a tree's trunk and/or posts.

The arthropod and mollusc arrangement may also be placed around the upper section of the tree's trunk, its branches and/or posts.

The arthropod and mollusc arrangement may also be placed around fence posts or similar objects surrounding fields of plants that need protection.

The arthropod and mollusc arrangement may also be placed directly on the ground in various lengths to form a barrier between plants and pest and/or be laid directly onto the ground or surface and/or be laid around fields or in between rows of plants or trees.

The arrangement can also be fixed onto plant pots, seed beds, walls, pillars, buildings, greenhouses, etc.

The arthropod and mollusc arrangement may also be adapted to be used as a barrier for all plant types against all plants pests.

Hence when the snails and slugs attempt to cross the arthropod and mollusc arrangement in order to reach the higher parts of the tree or plant or post, or feed on the pesticide pellets in the arthropod and mollusc arrangement, they will die and the tree or plant will remain protected.

The arthropod and mollusc arrangement may be placed around the tree trunks and/or posts either by hand or mechanically.

The arthropod and mollusc arrangement may be adapted using existing technology over time to allow for faster mechanical applications thereof.

The arthropod and mollusc arrangement may be manufactured by means of a DIY kit.

The components of the arthropod and mollusc arrangement may be any colour or pattern.

The components of the arthropod and mollusc arrangement may be any width, thickness and length.

The pesticide pellets may include arthropodicides and molluscicides.

The pesticide pellets may include other arthropodicides and molluscicides in this format, such as barriers against all arthropod, mites, nematodes, ants, worms, weevils, arachnids, myriapods and gastropods.

The arthropod and mollusc arrangement may include fipronil and/or alpha-cypermethrin and/or carbaryl and/or sodium fluorosilicate and/or bifenthrin and/o hydramethylnon and/or pyrethrum and/or boric acid and/or deltamethrin and/or pyrethroid and/or IGR (insect growth regulator), etc.

The pesticide pellets may be hard or soft.

The pesticide pellets may be dry, moist, wet and/or sticky

The pesticide may be applied or presented in liquid form.

The arthropod and mollusc arrangement may be applied with a plant tape tying tool and/or special built applicator and/or tape dispenser.

### BRIEF DESCRIPTION OF DRAWINGS

The invention will now be described by way of example with reference to the accompanying schematic drawings.

In the drawings there is shown in

FIG. 1: an image of an arthropod and mollusc arrangement according to the invention;

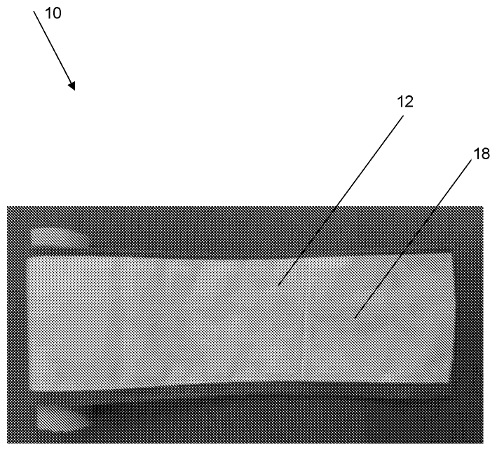

FIG. 2: an image of the arthropod and mollusc arrangement shown in FIG. 1 attached to the trunk of a tree;

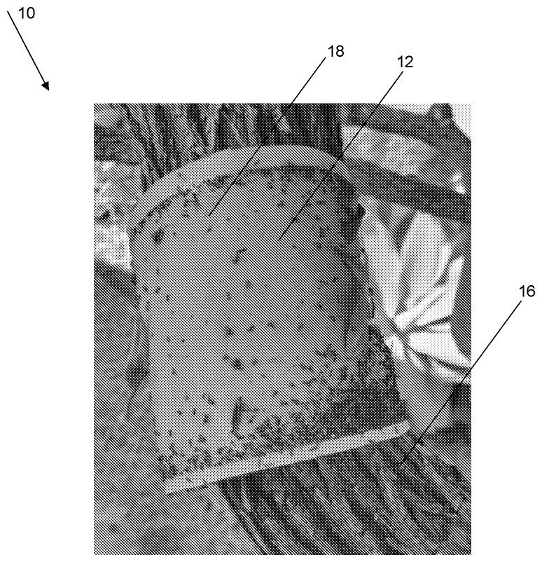

FIG. 3: an image of the batting of the arthropod and mollusc arrangement shown in FIG. 1;

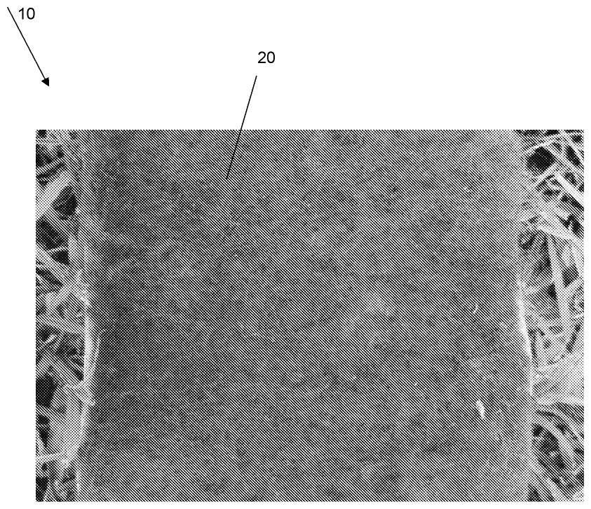

FIG. 4: an image of pesticide pellets adapted to be attached to the arthropod and mollusc arrangement shown in FIG. 1;

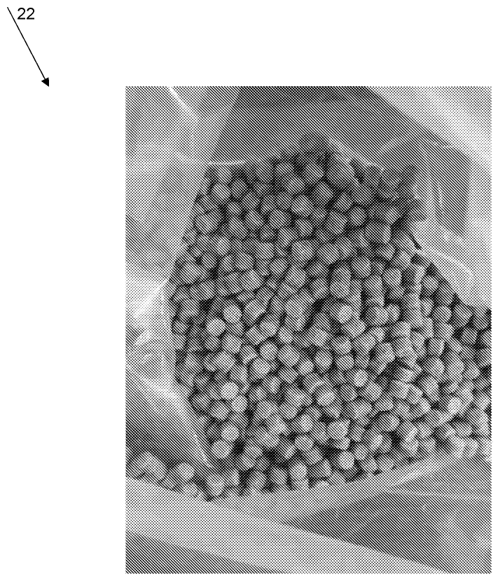

FIG. 5: an image showing how the pesticide pellets shown in FIG. 4 are glued to the outer surface of the arthropod and mollusc arrangement as shown in FIG. 1; and

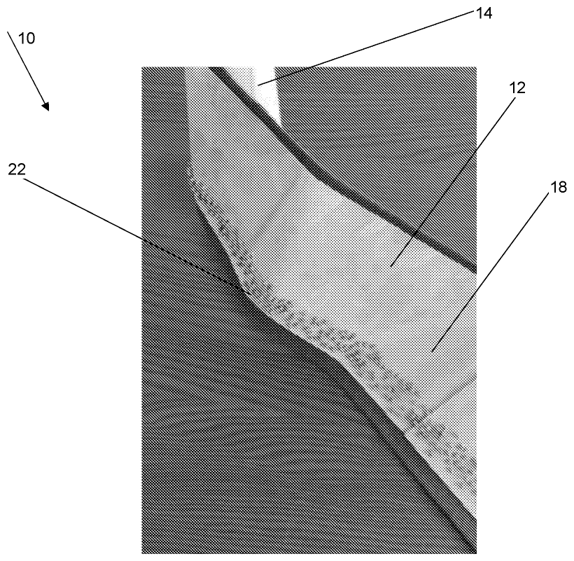

FIG. 6: an image of the arthropod and mollusc arrangement shown in FIG. 5 attached to the trunk of a tree.

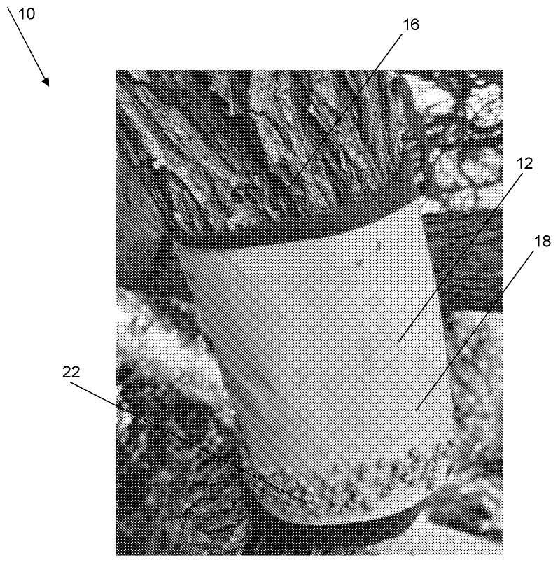

### DETAILED DESCRIPTION OF DRAWINGS

Referring to the drawings, there is shown an arthropod and mollusc arrangement in accordance with the invention, being generally indicated by reference numeral 10.

According to the invention, an arthropod and mollusc arrangement 10 includes a band 12 having
(a) an inner side 14 adapted to be attached to a trunk of a tree 16;
(b) an outer side 18 having a sticky surface and being adapted to trap crawling arthropod and molluscs trying to cross the band 12; and
(c) batting material 20 attached to the inner side 14 and being adapted to fill crevasses on the bark of the trunk of the tree 16 in order to prevent arthropod and mollusc s to crawl between the band 12 and the trunk of the tree 16.

The band 12 can be tensioned.

The batting material 20 is adapted to fill the crevasses on the inner side as the band 12 is tensioned when applied around the trunk of the tree 16.

When the crevasses are closed by the batting material 20, the arthropod and mollusc s are forced to cross over the outer side of the band 12 and get trapped in the sticky surface.

The sticky surface of the outer side 18 includes glue.

The outer side 18 is sticky and is adapted to trap crawling arthropod and mollusc s such as ants, beetles, weevils, earwigs, etc. trying to cross the band trying to reach the top of the tree 16.

The arthropod and mollusc arrangement 10 can be used without pesticides and may thus be non-chemical free and/or toxic-free.

Arthropodicides, molluscicides, and other pesticides can however be applied to the band 12.

Arthropodicides, molluscicides and other pesticides can be applied to the surface of the inner side 14 of the band 12 and/or the outer side 18 of the band 12.

The arthropodicides, molluscicides and other pesticides can be sprayed onto the band 12.

The batting material 20 can be treated and/or sprayed with an arthropodicide and molluscicide (various types) to act as a further barrier against arthropod and molluscs attempting to crawl underneath the band 12 to reach the top of the tree 16.

When the arthropods and molluscs come into contact with the treated batting material 20, they may die.

The arthropod and mollusc arrangement 10 can be adapted to act as a vehicle (or method) to apply existing arthropodicides and molluscicides.

Regular snail bait and/or pellets 22 can be applied to the outer side 18 of the band 12.

The snail bait and/or pellets 22 can be glued to the band 12.

The arthropod and mollusc arrangement 10 can thus be adapted to act as a vehicle (or method) to apply molluscicides.

When snails and slugs try to cross the pellets 22 to reach the top of the tree 16, they feed and die as a result of consumption or contact.

The bond of the pellets 22 to the band 12 is stronger than known products.

The manufacturing process of the arthropod and mollusc arrangement 10 is much improved, simpler, faster and ultimately more cost effective than known processes.

The arthropod and mollusc arrangement 10 can be adapted to act as a snail bait and/or other arthropod and molluscs baits.

The outer side 18 can be adapted to act as an arthropodicide and molluscicide and hence when arthropods and molluscs try to cross the baits, they feed and die on contact.

The arthropod and mollusc arrangement 10 can be adapted to be used as a barrier to prevent snails and slugs from climbing up tree trunks and/or posts to feed on the higher lying foliage, flowers and fruits or to seek refuge.

The arthropod and mollusc arrangement 10 can placed around the bottom section of a tree's trunk and/or posts.

The arthropod and mollusc arrangement 10 can also be placed around the upper section of the tree's trunk, its branches and/or posts.

The arthropod and mollusc arrangement 10 can also be placed around fence posts or similar objects surrounding fields of plants that need protection.

The arthropod and mollusc arrangement 10 can also be placed directly on the ground in various lengths to form a barrier between plants and pest and/or be laid directly onto the ground or surface and/or be laid around fields or in between rows of plants or trees.

The arthropod and mollusc arrangement 10 can also be adapted to be used as a barrier for all plant types against all plants pests.

Hence when the snails and slugs attempt to cross the arthropod and mollusc arrangement 10 in order to reach the higher parts of the tree or plant or post, or feed on the pesticide pellets in the arthropod and mollusc arrangement, they will die and the tree or plant will remain protected.

The arthropod and mollusc arrangement 10 can be placed around the tree trunks and/or posts either by hand or mechanically.

The arthropod and mollusc arrangement 10 can be adapted using existing technology over time to allow for faster mechanical applications thereof.

The arthropod and mollusc arrangement 10 can be manufactured by means of a DIY kit.

The pesticide pellets 22 can include molluscicides.

The pesticide pellets 22 can include other arthropod and mollusc icides in this format, such as barriers against all arthropod and mollusc s, mites, nematodes, ant worms, vine weevil and gastropods.

The arthropod and mollusc arrangement 10 can include fipronil and/or alpha-cypermethrin and/or carbaryl and/or sodium fluorosilicate.

The pesticide pellets 22 be hard or soft.

The pesticide pellets 22 can be dry, moist, wet and/or sticky.

The arthropod and mollusc arrangement 10 can be applied with a plant tape tying tool and/or applicator.

The arthropod and mollusc arrangement 10 can have the following properties:
(a) be of various widths
(b) be made of several types of materials including certain biodegradable materials
(c) be used to apply various types of pesticides including organic pesticides and biocides
(d) be used as a tree band with non-toxic glue without any pesticide and batting
(e) be used as a tree band with toxic glue without any pesticide or batting
(f) be used as a tree band with non-toxic glue with inner batting and without any pesticide
(g) be used as a tree band with non-toxic glue with inner batting and with a single pesticide (arthropodicide or molluscicide)
(h) be used as a tree band with non-toxic glue with inner batting and with a multiple pesticide (arthropodicide or molluscicide)
(i) be placed on the ground between plants to trap and kill pest (arthropods and gastropods)

1.-41. (canceled)

42. An arthropod and mollusc arrangement, which includes a band having an inner side adapted to be attached to a trunk of a tree; an outer side having a sticky surface and being adapted to trap crawling arthropod and molluscs trying to cross the band; and batting material attached to the inner side and being adapted to fill crevasses on the bark of the trunk of the tree in order to prevent arthropod and molluscs to crawl between the band and the trunk of the tree.

43. The arrangement as claimed in claim 42, in which the band is tensioned.

44. The arrangement as claimed in claim 42, in which the batting material is adapted to fill the crevasses on the inner side as the band is tensioned when applied around the trunk of the tree.

45. The arrangement as claimed in claim 44, in which when the crevasses are closed by the batting material, the arthropod and molluscs are forced to cross over the outer side of the band and get trapped in the sticky surface.

46. The arrangement as claimed in claim 42, in which the sticky surface includes glue and/or substances that are slippery, greasy, oily or contain surfactants or other chemicals or have characteristics that are deterring, prohibitive or preventative to arthropods and molluscs wanting to cross it.

47. The arrangement as claimed in claim 42, which is used without pesticides and is thus non-chemical free and/or toxic-free and/or pesticide-free.

48. The arrangement as claimed in claim 42, in which arthropod and molluscicides, molluscicides and other pesticides are
(a) applied to the band and/or impregnated into the band material; and/or
(b) applied to the surface of the inner side of the band and/or the outer side of the band; and/or
(c) sprayed onto the band.

49. The arrangement as claimed in claim 42, in which the batting material is treated and/or sprayed with an arthropodicides and molluscicide (various types) to act as a further barrier against arthropods and molluscs attempting to crawl underneath the band to reach the top of the tree.

50. The arrangement as claimed in claim 42, in which regular snail bait and/or pellets are applied to the outer side of the band and/or snail bait and/or pellets are glued to the band.

51. The arrangement as claimed in claim 42, which is adapted
(a) to act as a snail bait and/or other arthropod and molluscs baits; and/or
(b) to be used as a barrier to prevent snails and slugs from climbing up tree trunks and/or posts to feed on the higher lying foliage, flowers and fruits or to seek refuge; and/or
(c) to be placed around the bottom section of a tree's trunk and/or posts; and/or
(d) to be placed around the upper section of the tree's trunk, its branches and/or posts; and/or
(e) to be placed around fence posts or similar objects surrounding fields of plants that need protection and be adapted to be fixed onto plant pots, seed beds, walls, pillars, buildings and greenhouses; and/or
(f) to be placed directly on the ground in various lengths to form a barrier between plants and pest and/or be laid directly onto the ground or surface and/or be laid around fields or in between rows of plants or trees.

52. The arrangement as claimed in claim 42, in which when a snails and slugs attempt to cross the arthropod and mollusc arrangement in order to reach the higher parts of the tree or plant or post, or feed on the pesticide pellets in the arthropod and mollusc arrangement, they will die and the tree or plant will remain protected.

53. The arrangement as claimed in claim 50, in which the pesticide pellets include other arthropod and molluscicides in this format, such as barriers against all arthropod and molluscs, mites, nematodes, ant worms, weevils, myriapods, arachnids, and gastropods.

54. The arrangement as claimed in claim 42, which includes fipronil and/or alpha-cypermethrin and/or carbaryl and/or sodium fluorosilicate and/or bifenthrin and/or hydramethylnon and/or pyrethrum and/or boric acid and/or deltamethrin and/or pyrethroid and/or IGR (insect growth regulator).

55. The arrangement as claimed in claim 42, which includes glue containing human and mammal taste repellent such as denatonium benzoate and/or human and mammal smell deterrents.

56. The arrangement as claimed in claim 42, which is visually deterring to humans or mammals.
